(19) United States
(12) Patent Application Publication
(10) Pub. No.: US 2015/0011441 A1
(43) Pub. Date: Jan. 8, 2015

(54) Mutual Solvent for Downhole Use

(71) Applicants: Sarkis R. Kakadjian, The Woodlands, TX (US); Stephen Huber, The Woodlands, TX (US); Violeta Ramos, Houston, TX (US); Frank Zamora, San Antonio, TX (US)

(72) Inventors: Sarkis R. Kakadjian, The Woodlands, TX (US); Stephen Huber, The Woodlands, TX (US); Violeta Ramos, Houston, TX (US); Frank Zamora, San Antonio, TX (US)

(21) Appl. No.: 13/934,316

(22) Filed: Jul. 3, 2013

(51) Int. Cl. C09K 8/68; C09K 8/60

(52) U.S. Cl. CPC C09K 8/68; C09K 8/601
USPC 507/216; 507/261; 507/259; 507/211; 507/219

(57) ABSTRACT

A mutual solvent for use in oil and gas well operations comprising an ethoxylated alcohol surfactant, having a six carbon backbone chained to three ethylene oxide groups with a hydrophilic lipophilic balance between 11 and 12 but more preferably of about 11.3. Such a mutual solvent may be used in an oil and gas well as a spacer system, in acid treatments to remove the spent acid, and in solvent systems to remove asphaltenic or paraffinic compounds.

### BACKGROUND

Mutual solvents are typically additives used in oil field and well applications that are soluble in oil, water and acid-based treatment fluids. A commonly used mutual solvent is ethylene glycol mono butyl ether. Ethylene glycol mono butyl ether is routinely used in a range of applications, such as removing heavy hydrocarbon deposits, controlling the wettability of contact surfaces before, during or after a treatment, and preventing or breaking emulsions.

The mutual solvent may also be used within a spacer formulations to remove the oil film left on both the formation and metals in the well so that cement will bond to both the metal tubulars and the formation during a cementing operation. The mutual solvent may also be used after an acid treatment of the well to facilitate the removal of the spent acid from the producing formation. Additionally an oil or gas well may produce asphaltic or paraffinic hydrocarbons that tend to accumulate on the walls, casing, tubing, etc. of the well or drilling equipment. In addition, deposits of acid-soluble material, such as calcium carbonate, may accumulate slowing production. Before such deposits can be removed from the well a solvent is required that will strip off the asphaltenic or paraffinic hydrocarbons that tends to accumulate on such acid-soluble material.

Typically a mutual solvent is soluble in both aqueous and oleaginous fluids. Depending upon the solvent, the solvent may be substantially or completely soluble in each phase. Common mutual solvents are mainly based on glycols such as ethylene glycol mono butyl ether. Unfortunately ethylene glycol mono butyl ether is highly toxic and as such is less desirable as part of either spacers, acids treatments, or solvent treatments. Alternative mutual solvents such as poly (ethylene glycol) butyl ether blends have been in very short supply. While other solvents such as methyl ether ketones have extremely low flash points. Due to growing health and safety concerns, availability, and unacceptably low flash points there is a need for a mutual solvent for use in at least spacer systems, acid treatments, and downhole solvent packages.

### SUMMARY

A new alternative to the mutual solvents mentioned above is the use of an ethoxylated alcohol surfactant having a hydrophilic lipophilic balance between 11 and 12 but more preferably of about 11.3. Typically the preferred ethoxylated alcohol surfactant is C6-3EO has a six carbon backbone chained to three ethylene oxide groups having a hydrophilic lipophilic balance of about 11.3. The hydrophilic lipophilic balance or HLB is typically found by taking the molecular weight of the ethylene oxide groups and dividing them by the molecular weight of the whole system times 20 or ([#EO groups/(#C+EO groups)]*20=HLB). The C6-3EO ethoxylated alcohol surfactant has been found to be effective when used in spacer systems, acid treatment systems, and solvent systems. Additionally, the C6-3EO ethoxylated alcohol surfactant when used with an acid treatment system tends to facilitate the separation of hydrocarbons from the spent acid and other aqueous fluids while such fluids are being produced from the hydrocarbon formation to the surface in the wellbore thereby eliminating or minimizing the need for such separation on the surface.

The ethoxylated alcohol surfactant having an HLB between about 11 and 12, typically C6-3EO, is a unique alkoxylated solvent that provides mutual solvency, wettability modification, breaks and prevents water-oil emulsions. The primary application is use as a mutual solvent in stimulation and workover fluids for treating oil and gas producing wells or injection/disposal wells. C6-3EO is very useful for destabilizing existing emulsions and preventing the formation of further emulsions in both aqueous and hydrocarbon systems. C6-3EO offers the additional benefit of shale and clay stabilization. As the molecule contacts clay minerals it forms a protective layer which prevents dissolution of the key cationic components.

One embodiment of the present invention is a chemical for use in oil and gas well operations where an ethoxylated alcohol surfactant may have a hydrophilic lipophilic balance between 11 and 12 and where the ethoxylated alcohol surfactant may used as a mutual solvent. More preferably the ethoxylated alcohol surfactant has a hydrophilic lipophilic balance of about 11.3. Typically ethoxylated alcohol surfactant has a six carbon backbone chained to three ethylene oxide groups.

In another embodiment of the present invention an acid system has an acid and a mutual solvent where the mutual solvent is an ethoxylated alcohol surfactant having a hydrophilic lipophilic balance between 11 and 12. More preferably the ethoxylated alcohol surfactant has a hydrophilic lipophilic balance of about 11.3. Typically the ethoxylated alcohol surfactant has a six carbon backbone chained to three ethylene oxide groups. In many instances the acid is hydrochloric acid although any acid may be used.

Another embodiment of the present invention is spacer system for use in a wellbore consisting primarily of water, a water-soluble viscosifier, a weighting agent, a water wetting agent, a sulfonic acid surfactant, and a mutual solvent. Typically the mutual solvent is an ethoxylated alcohol having a hydrophilic lipophilic balance between 11 and 12. More preferably the ethoxylated alcohol has a hydrophilic lipophilic balance of about 11.3. Additionally the ethoxylated alcohol typically has a six carbon backbone chained to three ethylene oxide groups. In many instances the water-soluble viscosifier is a polysaccharide and derivatives although it may also be a synthetic polymer.

In this particular embodiment the water-soluble viscosifier is hydroxyethyl cellulose although other water-soluble viscosifiers may be used. In this particular embodiment the weighting agent is barite although other weighting agents may be used. In this particular embodiment the water wetting agent is tridecyl alcohol with six ethylene oxide groups although other water wetting agents may be used. In this particular embodiment the sulfonic acid surfactant is neutralized dodecyl benzene sulfonic acid although other sulfonic acid surfactants and derivatives may be used.

In this particular embodiment the mutual solvent may be present in an amount from about 0.1 pounds per barrel to about 70 pounds per barrel although it is preferable to have the mutual solvent present in an amount from about 1 pound per barrel to about 25 pounds per barrel and is even more preferable to have the mutual solvent present in an amount from about 2 pounds per barrel to about 7 pounds per barrel.

In this particular embodiment the viscosifying agent may be present in an amount from about 0.01 pounds per barrel to about 10 pounds per barrel although it is preferable to have the viscosifying agent present in an amount from about 0.5 pounds per barrel to about 7 pounds per barrel and is even more preferable to have the viscosifying agent present in an amount from about 1 pound per barrel to about 3 pounds per barrel.

In this particular embodiment the water wetting agent may be present in an amount from about 0.1 pounds per barrel to about 25 pounds per barrel although more preferably the water wetting agent is present in an amount from about 0.5 pounds per barrel to about 5 pounds per barrel and even more preferably the water wetting agent is present in an amount from about 1 pound per barrel to about 3.5 pounds per barrel.

In this particular embodiment the sulfonic acid surfactant may be present in an amount from about 0.1 pounds per barrel to about 25 pounds per barrel although more preferably the sulfonic acid surfactant may be present in an amount from about 0.5 pounds per barrel to about 5 pounds per barrel and even more preferably the sulfonic acid surfactant is present in an amount from about 1 pound per barrel to about 3.5 pounds per barrel.

### BRIEF DESCRIPTION OF THE DRAWINGS

FIG. 1 depicts a table of the solubility of various mutual solvents in both aqueous fluids and hydrocarbons.

FIG. 2 depicts the surface tension reduction of the ethoxylated alcohols surfactant C6-3 EO compared to other mutual solvents.

FIG. 3A-3F depicts the stratification of the hydrocarbon added acid system in the presence of various mutual solvents.

FIG. 4A-4D depicts the effect of the C6-3EO ethoxylated alcohol surfactant in a spacer system.

### DETAILED DESCRIPTION

The description that follows includes exemplary apparatus, methods, techniques, or instruction sequences that embody techniques of the inventive subject matter. However, it is understood that the described embodiments may be practiced without these specific details.

Exemplary paragraphs below give examples various mixtures and ranges chemicals to be effective.

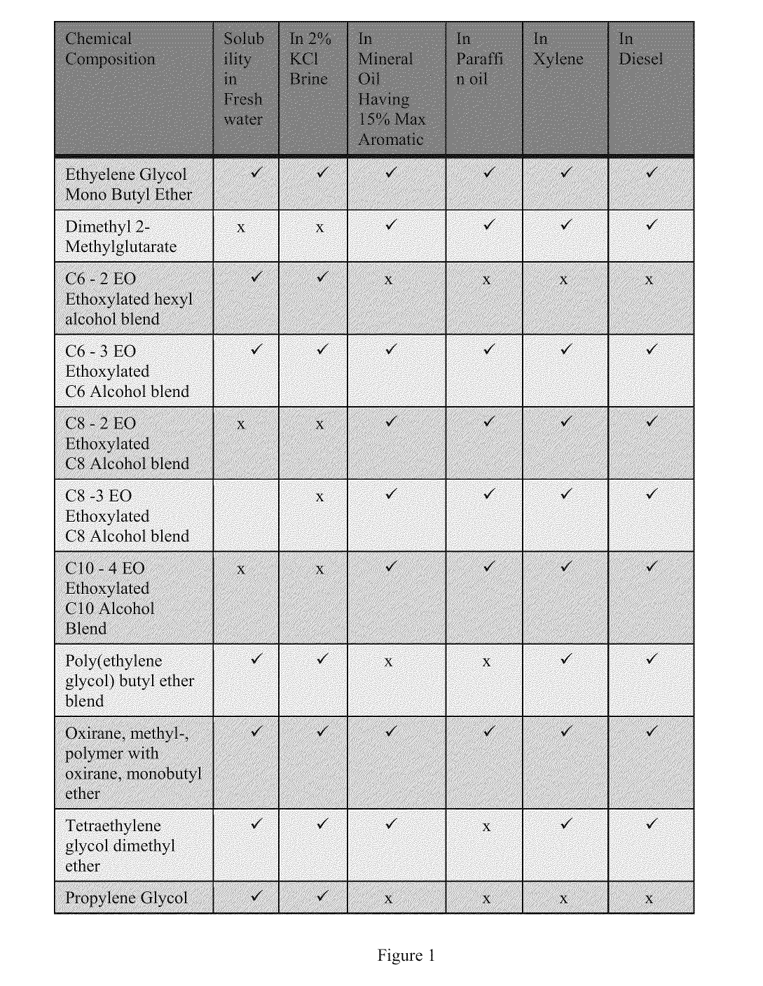

FIG. 1 is a table that depicts the results of test of a 10% solvent in freshwater, in a 2% KCl brine in a mineral oil with 15% maximum aromatics, in a paraffinic oil, in xylene, and in diesel. A check in the appropriate box indicates that the 10% solvent was soluble in the particular fluid. And ask in the appropriate box indicates that the 10% solvent was not soluble in the particular fluid. A 10% solvent is preferably used as a compromise between effectiveness and cost although in certain instances as low as 5% solvent or as high as 20% solvent may be used in a well. Higher solvent amounts than 20% may be used with diminishing effectiveness for greater cost.

As can be seen in FIG. 1 five solvents were generally considered to be effective as a mutual solvent. These were ethylene glycol mono butyl ether; C6-3 EO; poly (ethylene glycol) butyl ether blend; oxirane, methyl-, polymer with oxirane, monobutyl ether; and tetraethylene glycol dimethyl ether. Of the five mutual solvents that were generally considered to be effective to varying degrees, three of them are considered to be toxic. The three toxic mutual solvents are ethylene glycol mono butyl ether; oxirane, methyl-, polymer with oxirane, monobutyl ether; and tetraethylene glycol dimethyl ether. While poly(ethylene glycol) butyl ether blend is generally considered effective as a mutual solvent it is becoming increasingly scarce.

The remaining solvents in FIG. 1 were insoluble in either an aqueous solution or in soluble and oleaginous solution. Four of the solvents including dimethyl 2-methylglutarate; an ethoxylated alcohol surfactant; C8-2EO having an eight carbon backbone chained to two ethylene oxide groups with a hydrophilic lipophilic balance of about 8.1; C8-3EO having an eight carbon backbone chained to three ethylene oxide groups with a hydrophilic lipophilic balance of about 10.1; and C10-4EO having a Len carbon backbone chained to four ethylene oxide groups with a hydrophilic lipophilic balance of about 10.5 were all generally insoluble in an aqueous solution but soluble and oleaginous solution. The other two solvents C6-2EO having a six carbon backbone chained to two ethylene oxide groups with a hydrophilic lipophilic balance of about 9.3; and propylene glycol were soluble in an aqueous solution but insoluble in an oleaginous solution.

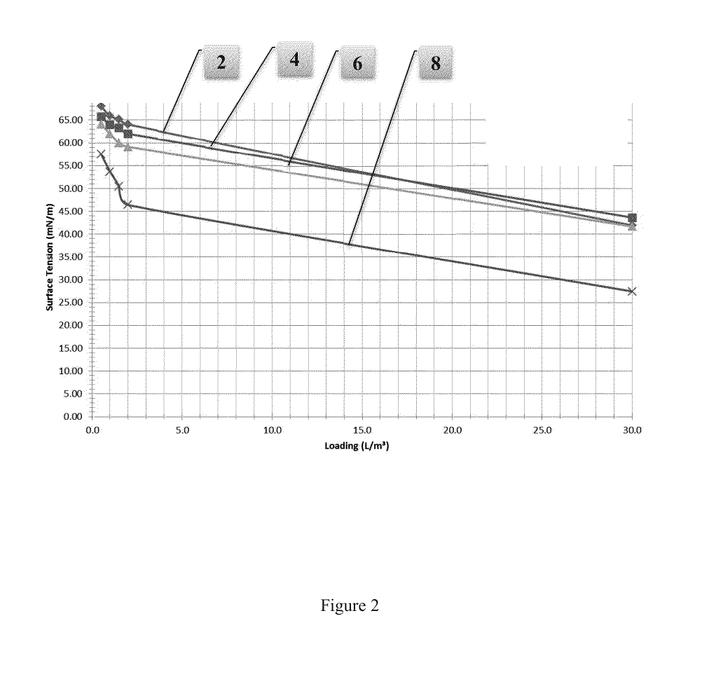

FIG. 2 depicts the reduction surface tension of water as a function of the amount of mutual solvent present. Line 2 depicts a combination of 6% HCl and 1½% Hydrofluoric acid. Line 4 depicts a polyethylene glycol) butyl ether blend. Line 6 depicts a glycol ether with both an ether and alcohol group in the same molecule. Line 8 depicts the ethoxylated alcohol surfactant C6-3EO. As can be readily seen in the graph the ethoxylated alcohol surfactant C6-3EO reduces the surface tension of water to about 43 mN/M utilizing about 7 L/m³ of C6-3EO whereas the other mutual solvents all require about 30 L/m³ of each solvent to reduce the surface attention of the water to about the same level of 43 mN/M.

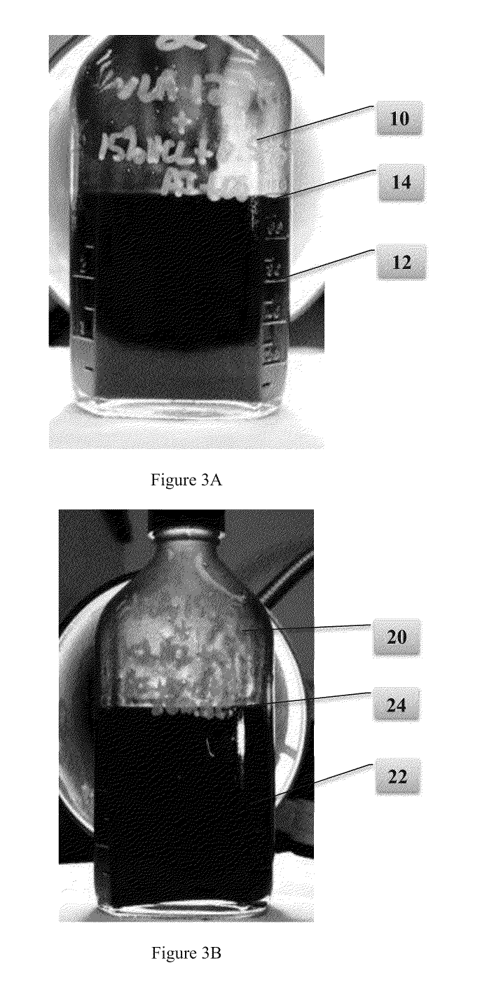

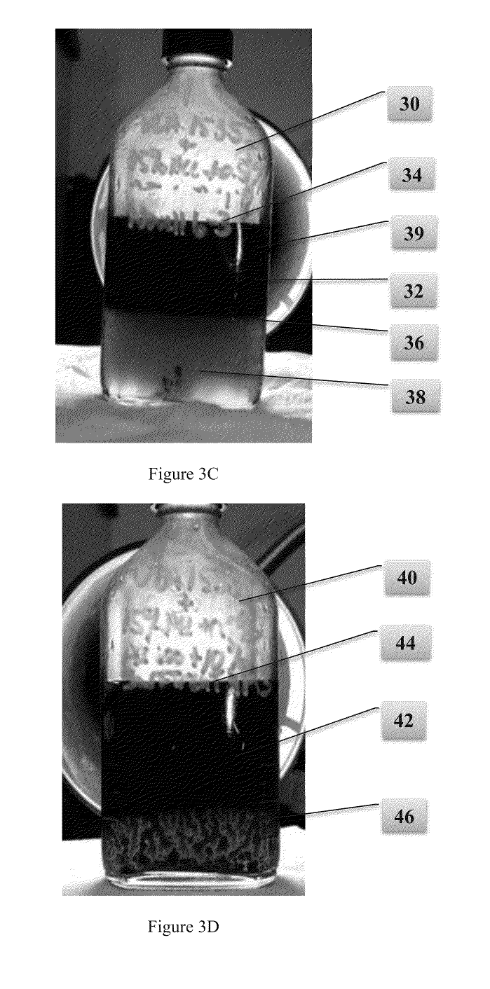

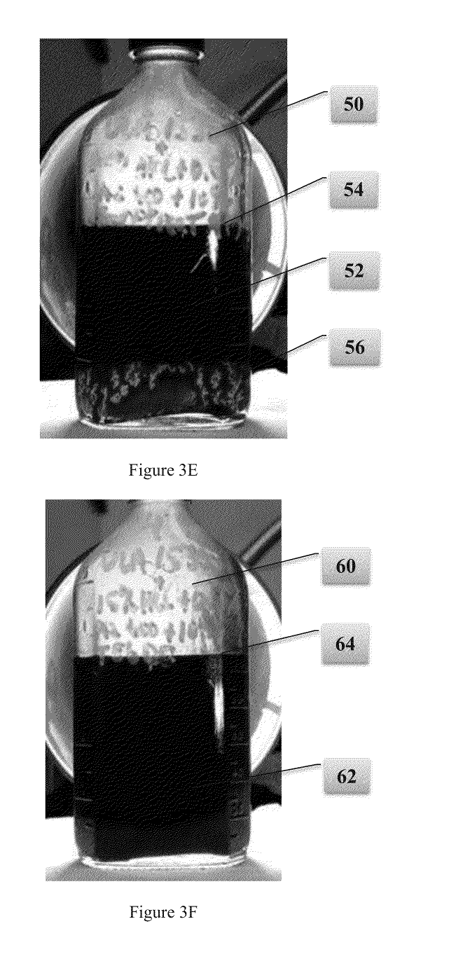

FIGS. 3A-3F depict the results of five solvents in FIG. 1 that were shown to be at least generally soluble in both aqueous and oleaginous solutions. The various solvents were mixed in a 15% acid system at 130° F. with wadell crude oil to replicate the effectiveness of the mutual solvent to help reduce the formation after an acid treatment. In some instances the mutual solvent binds with the acid and the hydrocarbon forming a homogenous mixture as the fluid is produced out of the well. It is preferred to use a mutual solvent that will cause separation between the spent acid and the hydrocarbon. Preferably the mutual solvent will cause separation between the spent acid and the hydrocarbon as the fluid is produced in the wellbore to the surface thereby precluding the need to treat the fluid on the surface as a be the case with an emulsified fluid. The separated fluid allows the hydrocarbon to be removed and/or easily separated from the spent acid. The test is meant to show the effect of a mutual solvent in producing a well after an acid treatment. The test used 15% HCl although the mutual solvent has been shown to work with virtually any acid.

In FIG. 3A the bottle 10 contains the mixture 12 of 15% acid and crude oil at 130° F. up to line 14. The mixture 12 contains 0.5% v/v of corrosion inhibitor Al-600, and does not incorporate a mutual solvent thus providing a homogenous mixture of the acid and crude oil. In FIG. 3B the bottle 20 contains the mixture 22 of 50% v/v of the acid blend which includes 10% v/v ethylene glycol mono butyl ether in the acid solution, and 50% v/v crude oil at 130° F. after mixed for 1 minute and left in water bath for 5 min @ 130 ° F. up to line 24. In FIG. 3C the bottle 30 contains the mixture of 50% v/v of the acid blend which includes 10% v/v a mixture 32 of 10% C6-3EO, and crude oil mixed for 1 minute and left in water bath for 5 min at 130° F. up to line 34. In FIG. 3D the bottle 40 contains the mixture 42 of 50% v/v of the acid blend which includes 10% v/, Poly (ethylene glycol) butyl ether and crude oil mixed for 1 minute and left in water bath for 5 min 130° F. up to line 44. In FIG. 3E the bottle 50 contains the mixture 52 of 50% v/v of the acid blend which includes 10% oxirane, methyl-, polymer with oxirane, monobutyl ether, and crude oil mixed for 1 minute and left in water bath for 5 min at 130° F. up to line 54. In FIG. 3F the bottle 60 contains the mixture 62 50% v/v of the acid blend which includes 10% v/v 10% tetraethylene glycol dimethyl ether and crude oil at 130° F. mixed for 1 minute and left in water bath for 5 min up to line 64. As can be seen in FIGS. 3B and 3F blends using the mutual solvents ethylene glycol monobutyl ether and tetraethylene glycol dimethyl ether do not appear to provide any separation between the spent acid and the hydrocarbon resulting in a homogeneous mixture. In FIGS. 3D and 3E the mutual solvents poly(ethylene glycol) butyl ether blend and oxirane, methyl-, polymer with oxirane, monobutyl ether provide a limited amount of separation between the spent acid below interface 46 in FIG. 3D and below interface 56 in FIG. 3E and the hydrocarbon above interface 46 in FIG. 3D and above interface 56 in FIG. 3E. FIG. 3C appears to show the solvent C6-3EO providing a highly delineated interface 36 between the acid 38 and the crude oil 39 leaving the inner surface of the glass jar adjacent to the acid 38 water wet.

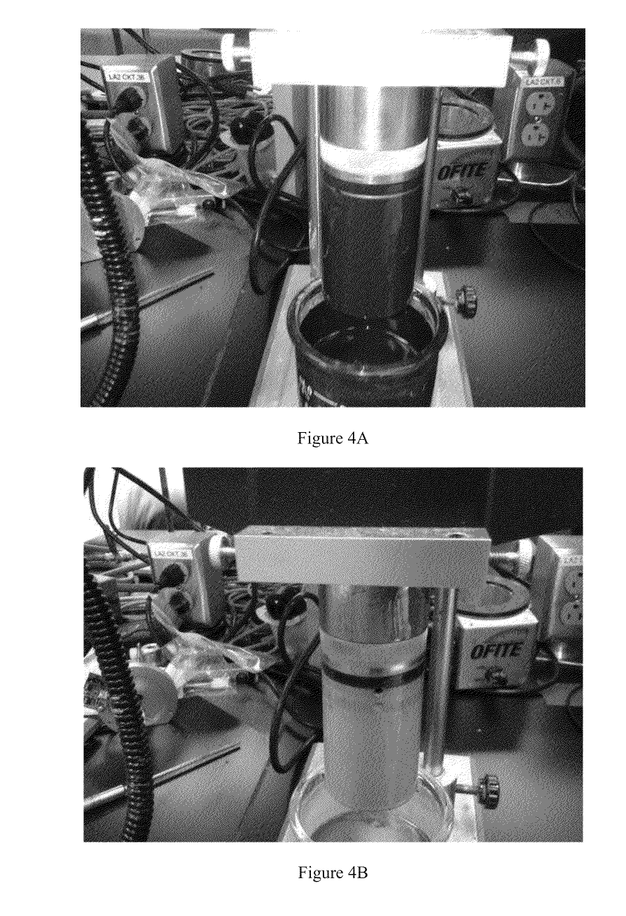

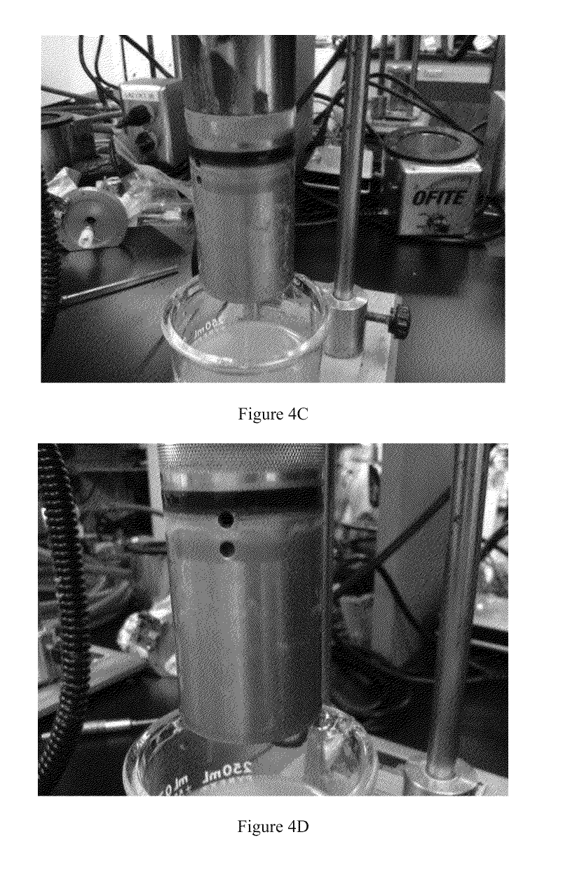

FIGS. 4A-4D depicts an embodiment of the mutual solvent C6-3EO in a spacer system as it would be used downhole. Typically the oil-based mud is used to help remove rock debris and metal shavings as well as provide formation pressure during drilling. Unfortunately the oil-based mud coats the steel and the formation leaving the film on the metal and the formation that tends to interfere with the bond between the cement, the steel tubular, and the formation. Therefore it is necessary before cementing a well after using an oil-based mud to ensure that the formation and the casing or water went which allows the cement to bond to both the steel and the formation. A good bond is necessary between the formation, the steel tubulars, and the cement to provide zone or wellbore isolation preventing any formation fluid from flowing along the exterior of the casing between zones to the surface.

FIG. 4A depicts a sleeve 100 having just been removed from immersion in an oil-based mud 110. The oil-based mud 110 coats the sleeve 100 leaving the thin film 112 of oil-based mud 100 on the surface of the sleeve 100. FIG. 4B depicts the sleeve 100 as it is removed from the spacer 110 after being exposed to the spacer 110 in beaker 112 for 6 minutes. FIG. 4C depicts the sleeve 100 after being rinsed with water for 10 seconds. FIG. 4D depicts the now clean, water wet sleeve 100 after being rinsed with water for 20 seconds. FIGS. 4A-4D indicate that a spacer system typically comprised of:

| | |
|---|---|
| 289 lb/bbl | water |
| 2 lb/bbl | Hydroxyethyl cellulose |
| 255 lb/bbl | Barite |
| 5.25 lb/bbl | Tridecyl alcohol with 6 ethylene oxide |
| 5.25 lb/bbl | Neutralized dodecyl benzene sulfonic |
| | acid |
| 8.33 lb/bbl | C6-3EO ethoxylated alcohol |

is able to quickly remove the thin film of oil-based mud to provide a water wet surface so that cement may bond to the steel or formation providing zone isolation.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A chemical for use in oil and gas well operations comprising:
an ethoxylated alcohol surfactant, having a hydrophilic lipophilic balance between 11 and 12;
wherein the ethoxylated alcohol surfactant is used as a mutual solvent.

2. The chemical for use in an oil and gas well operations of claim one 1 wherein the ethoxylated alcohol surfactant has a hydrophilic lipophilic balance of about 11.3.

3. The chemical for use in an oil and gas well operations of claim one 1 wherein the ethoxylated alcohol surfactant has a six carbon backbone chained to three ethylene oxide groups.

4. An acid system comprising:
an acid, and
a mutual solvent,
wherein the mutual solvent is an ethoxylated alcohol surfactant having a hydrophilic lipophilic balance between 11 and 12.

5. The acid system of claim 4 wherein the ethoxylated alcohol surfactant has a hydrophilic lipophilic balance of about 11.3.

6. The acid system of claim 4 where the ethoxylated alcohol surfactant has a six carbon backbone chained to three ethylene oxide groups.

7. The acid system of claim 4 wherein the acid is hydrochloric acid.

8. The acid system claim 4 wherein the mutual solvent is present in an amount from about 0.1 pounds per barrel to about 70 pounds per barrel.

9. The acid system claim 4 wherein the mutual solvent is present in an amount from about 1.0 pounds per barrel to about 25 pounds per barrel.

10. The acid system claim 4 wherein the mutual solvent is present in an amount from about 2.0 pounds per barrel to about 7 pounds per barrel.

11. A spacer system for use in a wellbore comprising:
a water;
a water-soluble viscosifier:
a weighting agent;
a water wetting agent;
a sulfonic acid surfactant;
and a mutual solvent;
wherein the mutual solvent is an ethoxylated alcohol having a hydrophilic lipophilic balance between 11 and 12.

12. The spacer system of claim 11 wherein the ethoxylated alcohol has a hydrophilic lipophilic balance of about 11.3.

13. The spacer system of claim 11 wherein the ethoxylated alcohol has a six carbon backbone chained to three ethylene oxide groups,

14. The spacer system of claim 11 wherein the water-soluble viscosifier is a polysaccharide.

15. The spacer system of claim 11 wherein the water-soluble viscosifier is a polysaccharide derivative.

16. The spacer system of claim 11 wherein the water-soluble viscosifier is a synthetic polymer.

17. The spacer system of claim 11 wherein the water-soluble viscosifier is hydroxyethyl cellulose.

18. The spacer system of claim 11 wherein the weighting agent is barite.

19. The spacer system of claim 11 wherein the water wetting agent is tridecyl alcohol with six ethylene oxide groups.

20. The spacer system of claim 11 wherein the sulfonic acid surfactant is neutralized dodecyl benzene sulfonic acid.

21. The spacer system of claim 11 wherein the mutual solvent is present in an amount from about 0.1 pounds per barrel to about 70 pounds per barrel.

22. The spacer system of claim 11 wherein the mutual solvent is present in an amount from about 1 pound per barrel to about 25 pounds per barrel.

23. The spacer system of claim 11 wherein the mutual solvent is present in an amount from about 2 pounds per barrel to about 7 pounds per barrel.

24. The spacer system of claim 11 wherein the viscosifying agent is present in an amount from about 0.01 pounds per barrel to about 10 pounds per barrel.

25. The spacer system of claim 11 where the viscosifying agent is present in an amount from about 0.5 pounds per barrel to about 7 pounds per barrel.

26. The spacer system of claim 11 wherein the viscosifying agent is present in an amount from about 1 pound per barrel to about 3 pounds per barrel.

27. The spacer system of claim 11 wherein the water wetting agent is present in an amount from about 0.1 pounds per barrel to about 25 pounds per barrel.

28. The spacer system of claim 11 wherein the water welting agent is present in an amount from about 0.5 pounds per barrel to about 5 pounds per barrel.

29. The spacer system of claim 11 wherein the water wetting agent is present in an amount from about 1 pound per barrel to about 3.5 pounds per barrel.

30. The spacer system of claim 11 wherein the sulfonic acid surfactant is present in an amount from about 0.1 pounds per barrel to about 25 pounds per barrel.

31. The spacer system of claim 11 wherein the sulfonic acid surfactant is present in an amount from about 0.5 pounds per barrel to about 5 pounds per barrel.

32. The spacer system of claim 11 wherein the sulfonic acid surfactant is present in an amount from about 1 pound per barrel to about 3.5 pounds per barrel.
